(19) United States
(12) Patent Application Publication
(10) Pub. No.: US 2026/0044868 A1
(43) Pub. Date: Feb. 12, 2026

(54) SERVICE PROVISION SYSTEM, IN-VEHICLE DEVICE, SERVER, STORAGE MEDIUM STORING SERVICE PROVISION PROGRAM, AND SERVICE PROVISION METHOD

(71) Applicant: DENSO CORPORATION, Kariya-city (JP)

(72) Inventors: Yukihiro YAMAKAWA, Kariya-city (JP); Hideyuki YAMAGUCHI, Kariya-city (JP); Hideyuki HONYA, Kariya-city (JP)

(21) Appl. No.: 19/365,288

(22) Filed: Oct. 22, 2025

Related U.S. Application Data
(63) Continuation of application No. PCT/JP2024/016032, filed on Apr. 24, 2024.

(30) Foreign Application Priority Data
Apr. 25, 2023 (JP) 2023-071589

(51) Int. Cl. G06Q 30/0201

(52) U.S. Cl. CPC G06Q 30/0201

(57) ABSTRACT

A service provision system comprises: a vehicle control system that includes: a plurality of electronic control units; and a coordination controller configured to perform coordination between a service application and a control system function block; and a server. The control system function block includes a functional interface configured to convert an access request into a vehicle-dependent format. The coordination controller transfers the access request to the control system function block. The service provision system is further configured to: acquire current and feature vehicle information; calculate a current interface use fee; calculate a first future estimation amount that is an estimation amount of the interface use fee; acquire future external system information; and calculate a second future estimation amount.

### CROSS REFERENCE TO RELATED APPLICATIONS

The present application is a continuation application of International Patent Application No. PCT/JP2024/016032 filed on Apr. 24, 2024, which designated the U.S. and claims the benefit of priority from Japanese Patent Application No. 2023-071589 filed on Apr. 25, 2023. The entire disclosures of all of the above applications are incorporated herein by reference.

### TECHNICAL FIELD

The present disclosure relates to a service provision system, an in-vehicle device, a server, a service provision program, and a service provision method for providing a service to a vehicle.

### BACKGROUND

A sharing mobility system has been known as a comparative example, and includes multiple user terminals used by a user using a vehicle, multiple carport devices placed at a carport, and a server managed by a provider that provides a mobility service to the user. In the sharing mobility system of the comparative example, a server calculates an estimated revenue amount that the provider can obtain from the user when the user uses a vehicle that is parked at the carport and can be used.

### SUMMARY

According to an aspect of the present disclosure, a service provision system comprises: a vehicle control system that includes: a plurality of electronic control units; and a coordination controller configured to perform coordination between a service application and a control system function block; and a server. The control system function block includes a functional interface configured to convert an access request into a vehicle-dependent format. The coordination controller transfers the access request to the control system function block. The service provision system further comprises at least one of (i) a circuit and (ii) a processor with a memory storing computer program code executable by the processor, the at least one of the circuit and the processor configured to cause the service provision system to: acquire current and feature vehicle information; calculate a current interface use fee; calculate a first future estimation amount that is an estimation amount of the interface use fee; acquire future external system information; and calculate a second future estimation amount.

### BRIEF DESCRIPTION OF DRAWINGS

FIG. 1 is a block diagram showing a configuration of a service provision system.

FIG. 2 is a block diagram showing a configuration of an ECU.

FIG. 3 is a block diagram showing a charging procedure.

FIG. 4 is a block diagram showing a transmission path of information.

FIG. 5 is a diagram showing an API use fee limit setting window.

FIG. 6 is a sequence diagram showing a procedure for an API gateway to calculate a current API use fee.

FIG. 7 is a diagram showing a configuration of API estimation amount information generated by the API gateway.

FIG. 8 is a sequence diagram showing a procedure for an app store to calculate the future estimation amount of API use charges.

FIG. 9 is a diagram showing a configuration of API estimation amount information generated by the app store.

FIG. 10 is a flowchart showing a first calculation process.

FIG. 11 is a flowchart showing a second calculation process.

### DETAILED DESCRIPTION

When a service provider provides a service to a vehicle, it may be necessary to acquire vehicle information related to the vehicle from a target vehicle that is a service provision target, or cause the target vehicle to perform a predetermined operation or process.

In this way, when the service provider uses a vehicle by acquiring vehicle information from the vehicle or causing the vehicle to perform the predetermined operation or process, it is desirable to appropriately charge the service provider according to the use of the vehicle.

As a result of detailed studies by the inventors, it has been found that when calculating the future estimation amount of the use fee generated by the use of the vehicle by the service provider, it may be difficult to calculate the appropriate amount using only the data that can be acquired from the vehicle.

The present disclosure improves the reliability of a service provision system.

According to an aspect of the present disclosure, a service provision system includes: a vehicle control system including multiple electronic control units mounted on a vehicle and connected to an in-vehicle network; a coordination controller configured to implement coordination between a service application and a control system function block configured to control the vehicle; and a server configured to communicate data with the vehicle control system.

The control system function block includes a functional interface. The functional interface is configured to convert an access request that is expressed in a vehicle-independent format and transmitted from the service application into a vehicle-dependent format.

The coordination controller transfers the access request transmitted from the service application to the control system function block.

The service provision system includes a vehicle information acquisition unit, a use fee calculation unit, a first estimation amount calculation unit, an external information acquisition unit, and a second estimation amount calculation unit.

The vehicle information acquisition unit acquires current vehicle information that is current information related to the vehicle and future vehicle information that is future information related to the vehicle based on information transmitted from the multiple electronic control units.

The use fee calculation unit is configured to calculate a current interface use fee that is an interface use fee generated by a service application using the functional interface based on the current vehicle information.

The first estimation amount calculation unit calculates a first future estimation amount that is an estimation amount of an interface use fee generated by a future use of the functional interface by the service application based on the current vehicle information and the future vehicle information.

The external information acquisition unit acquires future external system information that is future information related to an external system from the external system existing outside the service provision system.

The second estimation amount calculation unit is configured to calculate a second future estimation amount that is an estimation amount of an interface use fee generated by a service application using the functional interface in the future based on the first future estimation amount information indicating the first future estimation amount and the future external system information.

The service provision system of the present disclosure configured in such a manner calculates a second future estimation amount, which is an estimation amount of an interface use fee generated by a service application using the functional interface in the future, based on not only the first future estimation amount information but also future external system information. Thereby, the service provision system of the present disclosure can improve the accuracy of calculating the estimation amount of interface use fee that will occur in the future due to the use of the functional interface by the service application. Therefore, the service provision system of the present disclosure can improve the reliability of the service provision system.

According to another aspect of the present disclosure, an in-vehicle device is mounted on a vehicle and connected to a plurality of electronic control units via an in-vehicle network, and includes a vehicle information acquisition unit, a use fee calculation unit, and a first estimation amount calculation unit.

The in-vehicle device of the present disclosure configured in this manner is a device included in the service provision system of the present disclosure and can achieve the same effects as the service provision system of the present disclosure.

Further, according to another aspect of the present disclosure, a server includes a communication unit configured to communicate with the vehicle control system, an external information acquisition unit, and a second estimation amount calculation unit.

The server of the present disclosure configured in this manner is a server in the service provision system of the present disclosure, and can achieve the same effects as the service provision system of the present disclosure.

Further, according to another aspect of the present disclosure, a service provision method is executed by a service provision system including a vehicle control system and a server.

The service provision system acquires current vehicle information and future vehicle information based on information transmitted from multiple electronic control units. The service provision system calculates a current interface use fee based on the current vehicle information. The service provision system calculates a first future estimation amount based on current vehicle information and future vehicle information.

The service provision system acquires future external system information from the external system. The service provision system calculates a second future estimation amount based on the first future estimation amount information and future external system information.

The service provision method of the present disclosure is a method executed by the service provision system of the present disclosure, and by executing the method, the same effects as those of the service provision system of the present disclosure can be achieved.

Further, according to another aspect of the present disclosure, a service provision program causes a computer of the in-vehicle device to function as a functional interface, a coordination controller, a vehicle information acquisition unit, a use fee calculation unit, and a first estimation amount calculation unit.

The computer controlled by the service provision program of the present disclosure can configure a part of the in-vehicle device of the present disclosure, and can achieve the same effects as the in-vehicle device of the present disclosure.

Further, according to another aspect of the present disclosure, a service provision method is executed by an in-vehicle device that is mounted on a vehicle and connected to multiple electronic control units by an in-vehicle network. The in-vehicle device includes a functional interface and a coordination controller. In the service provision method of the present disclosure, the in-vehicle device acquires current vehicle information and future vehicle information based on information transmitted from multiple electronic control units. The in-vehicle device calculates the current interface use fee based on the current vehicle information. The in-vehicle device calculates the first future estimation amount based on the current vehicle information and the future vehicle information.

The service provision method of the present disclosure is a method executed by the in-vehicle device of the present disclosure. By executing the method, the same effects as those of the in-vehicle device of the present disclosure can be achieved.

Further, according to another aspect of the present disclosure, a service provision program causes a computer to function as a communication unit, an external information acquisition unit, and a second estimation amount calculation unit.

The computer controlled by the service provision program of the present disclosure can configure a part of the server of the present disclosure, and can achieve the same effects as the server of the present disclosure.

Further, according to another aspect of the present disclosure, a service provision method is executed by a server of a service provision system including a vehicle control system including a functional interface and a server configured to communicate data with the vehicle control system. In the service provision method of the present disclosure, the server communicates data with the vehicle control system. The server acquires the first future estimation amount information. The server acquires future external system information from the external system. The server calculates the second future estimation amount based on the first future estimation amount information and the future external system information.

The service provision method of the present disclosure is a method executed by the server of the present disclosure. By executing the method, the same effects as those of the server of the present disclosure can be obtained.

Hereinafter, an embodiment of the present disclosure will be described with reference to the drawings.

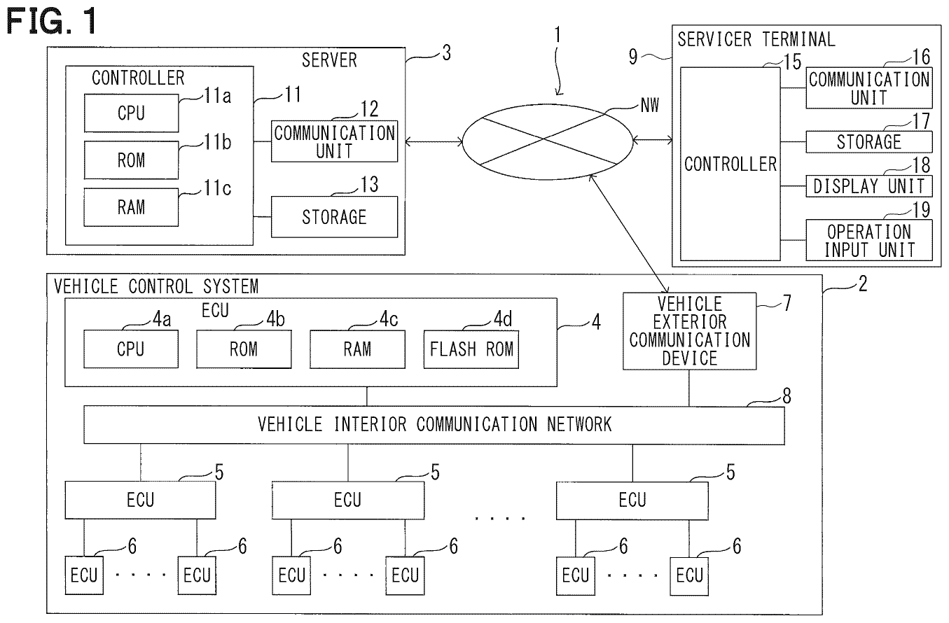

As shown in FIG. 1, a service provision system 1 of the present embodiment includes a vehicle control system 2 and a server 3.

The vehicle control system 2 is mounted on a vehicle and has a function of performing data communication with the server 3 via a wide area wireless communication network NW.

The server 3 has a function of performing data communication with the vehicle control system 2 via the wide area wireless communication network NW. An app store accessible via the wide area wireless communication network NW or the Internet is installed in the server 3.

A vehicle equipped with the vehicle control system 2 may have an automated driving function in addition to a manual driving function. The vehicle may be a hybrid vehicle having an engine and an electric motor as a traveling source. The vehicle is not limited to the vehicle having the automated driving function or the hybrid vehicle, but may be a vehicle having only a manual driving function, or a vehicle having only an engine or only an electric motor as the travel driving source. Hereinafter, the vehicle equipped with the vehicle control system 2 will be simply referred to as a vehicle.

The vehicle control system 2 includes one ECU 4, multiple ECUs 5, multiple ECUs 6, a vehicle exterior communication device 7, and a vehicle interior communication network 8. The ECU is an abbreviation for Electronic Control Unit.

The ECU 4 controls the multiple ECUs 5 to achieve coordinated control of the entire vehicle.

The ECU 5 is provided for each domain divided by function in the vehicle, and mainly controls multiple ECUs 6 existing within that domain. Each ECU 5 is connected to the ECU 6 under the control thereof via an individually provided lower layer network (for example, CAN). The CAN is an abbreviation for Controller Area Network. The CAN is a registered trademark. The domains are, for example, a powertrain, a body, a chassis, a cockpit, and the like.

The ECUs 6 connected to the ECU 5 belonging to the powertrain domain include, for example, an ECU 6 that controls an engine, an ECU 6 that controls a motor, and an ECU 6 that controls the battery.

The ECUs 6 connected to the ECU 5 belonging to the body domain include, for example, an ECU 6 that controls an air conditioner, and an ECU 6 that controls a door.

The ECUs 6 connected to the ECU 5 belonging to the chassis domain include, for example, an ECU 6 that controls braking, and an ECU 6 that controls steering.

The ECUs 6 connected to the ECU 5 belonging to the cockpit domain include, for example, an ECU 6 that controls display of a meter and navigation, and an ECU 6 that controls an input device operable by an occupant of the vehicle.

The vehicle exterior communication device 7 performs data communication with the server 3 via the wide area wireless communication network NW.

The vehicle interior communication network 8 includes CAN FD and Ethernet. The Ethernet is a registered trademark. The CAN FD is an abbreviation for CAN with Flexible Data Rate. The CAN FD connects the ECU 4 to each of the ECUs 5 and the vehicle exterior communication device 7 via a bus. The Ethernet individually connects the ECU 4 to each of the ECUs 5 and the vehicle exterior communication device 7.

The ECU 4 is an electronic control unit that mainly includes a microcomputer including a CPU 4a, a ROM 4b, and a RAM 4c. Various functions of the microcomputer are implemented by the CPU 4a executing programs stored in a non-transitory tangible storage medium. In this example, the ROM 4b corresponds to a non-transitory tangible storage medium that stores a program. Further, by executing this program, a method corresponding to the program is executed. Some or all of the functions executed by the CPU 4a may be configured in hardware using one or more ICs. Further, the number of the microcomputers constituting the ECU 4 may be one or more.

The ECU 4 further includes a flash ROM 4d. The flash ROM 4d is a non-volatile memory capable of rewriting the storage contents.

Like the ECU 4, the ECU 5, the ECU 6, and the vehicle exterior communication device 7 are each an electronic control unit mainly including a microcomputer including a CPU, a ROM and a RAM. Further, the number of microcomputers constituting each of the ECUs 5, each of the ECUs 6, and the vehicle exterior communication device 7 may be one or more. The ECU 5 controls one or more ECUs 6. The ECU 4 controls one or more ECUs 5, or controls the ECUs 5 and 6 of the entire vehicle and the vehicle exterior communication device 7.

Hereinafter, unless otherwise specified, the ECU 4, ECU 5, ECU 6, and the vehicle exterior communication device 7 will be collectively referred to as in-vehicle devices 4 to 7.

The server 3 includes a controller 11, a communication unit 12, and a storage 13.

The controller 11 is an electronic control unit mainly including a microcomputer including a CPU 11a, a ROM 11b, a RAM 11c, and the like. Various functions of the microcomputer are implemented by the CPU 11a executing programs stored in a non-transitory tangible storage medium. In this example, the ROM 11b corresponds to a non-transitory tangible storage medium that stores a program. Further, by executing this program, a method corresponding to the program is executed. Some or all of the functions executed by the CPU 11a may be configured in hardware using one or more ICs. The number of microcomputers included in the controller 11 may be one or more.

The communication unit 12 performs data communication with the vehicle control system 2 through the wide area wireless communication network NW. The storage 13 is a storage device for storing various data.

The service provision system 1 further includes a servicer terminal device 9. The servicer terminal device 9 is a device managed by a service provider SV (hereinafter, servicer SV) described later, and is, for example, a personal computer.

The servicer terminal device 9 includes a controller 15, a communication unit 16, a storage 17, a display unit 18, and an operation input unit 19.

The controller 15 is an electronic control unit mainly including a microcomputer with a CPU, a ROM, a RAM, and the like.

The communication unit 16 performs data communication with the vehicle control system 2 and the server 3 via the wide area wireless communication network NW. The storage 17 is a storage device for storing various data. The display unit 18 includes a display device (not shown) and displays various images on a display screen of the display device. The operation input unit 19 outputs input operation information for identifying input operations performed by the user via a keyboard and a mouse (not shown).

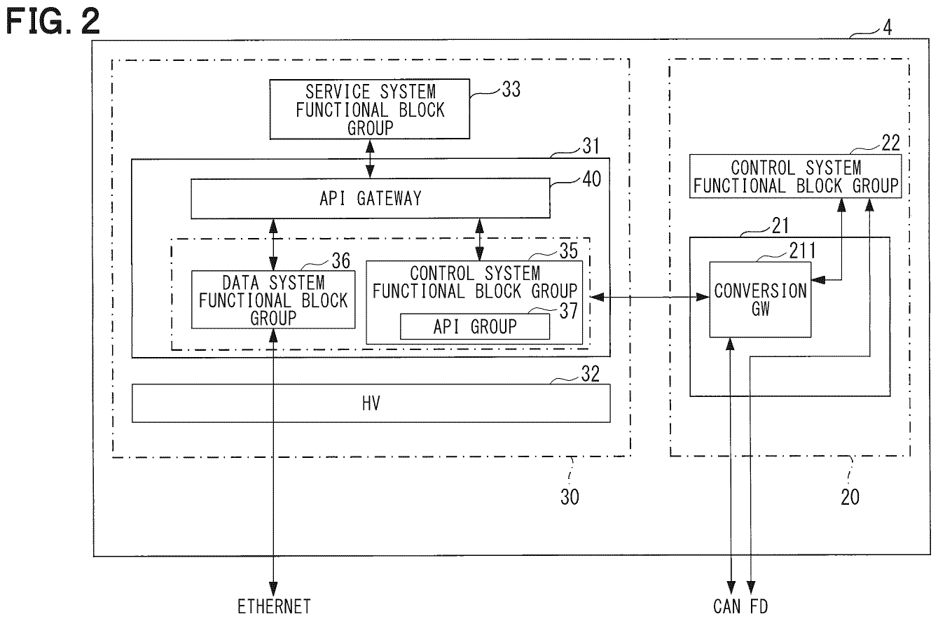

As shown in FIG. 2, the ECU 4 includes a real-time processing unit 20 and an application processing unit 30 (hereinafter also referred to as an app processing unit 30). When the ECU 4 includes multiple CPUs 4a, the real-time processing unit 20 and the application processing unit 30 may be implemented by processes executed by the same CPU or by processes executed by different CPUs.

The real-time processing unit 20 cooperates with the in-vehicle devices 5 to 7 connected via the CAN FD to execute vehicle control and the like that requires real-time performance. The application processing unit 30 cooperates with the in-vehicle devices 5 to 7 connected via Ethernet to execute various applications (for example, entertainment applications) that require high processing performance.

The application processing unit 30 has a function to transmit instructions based on the processes of various applications to the real-time processing unit 20. The real-time processing unit 20 has a function to transmit information, and the like collected from the ECU and the like, to the application processing unit 30 via the CAN FD. Thereby, the real-time processing unit 20 and the application processing unit 30 cooperate with each other to implement various functions.

The software of the vehicle control system 2 is built along AUTOSAR. The AUTOSAR is an architecture for automated driving and an abbreviation for Automotive Open System Architecture. The AUTOSAR is a registered trademark. The AUTOSAR provides not only communication between software components (hereinafter referred to as SW-C) provided to implement various applications, but also functions related to connection to the cloud, security, and the like. The SW-C is parted software to implement a certain function. The application program includes one or more SW-C. Note that the software of the vehicle control system 2 does not necessarily need to be built along AUTOSAR.

Each device belonging to the vehicle control system 2, that is, the ECU 4, the ECU 5, the ECU 6, and the vehicle exterior communication device 7, are all provided with a platform. The platform provides an environment for running SW-C written in a hardware-independent format.

The platform includes a runtime environment (hereinafter, RTE) and base software (hereinafter, BSW). The RTE is the interface between SW-C and between SW-C and BSW. The BSW is the hierarchy connecting hardware and SW-C, including OS, driver, middleware, etc. The functions of the BSW are divided into small modules and the functions of each module are provided to the SW-C via API. The API is an abbreviation for Application Programming Interface.

Hereinafter, the platform provided in the real-time processing unit 20 is referred to as a first platform 21 (hereinafter, first PF 21), and the platform provided in the application processing unit 30 is referred to as a second platform 31 (hereinafter, second PF 31).

The real-time processing unit 20 includes a control system function block group 22 as a collection of service applications (hereinafter referred to as service apps) operating on the first PF 21. The service app is an application that receives requests from clients, processes them, and returns results.

The control system function block group 22 is a group of applications for providing an API for accepting instructions related to the movement of the vehicle and for controlling the instructions accepted by the API to implement consistent vehicle control. The control system function block group 22 outputs various instructions via the vehicle interior communication network 8 to the in-vehicle devices 5 to 7 in which there is an object that executes control based on the directive.

The first PF 21 is provided with a conversion gateway 211. The conversion gateway 211 has a function to convert the communication frame received by the real-time processing unit 20 via the CAN FD into Ethernet format and provide it to the application processing unit 30. In addition, the conversion gateway 211 has a function to convert the communication frame in the Ethernet format provided by the application processing unit 30 to the CAN format.

The application processing unit 30 includes a hypervisor 32, and executes software on multiple virtual machines. Note that the hypervisor 32 may be omitted.

The application processing unit 30 includes a service system function block group 33 as a collection of service applications operating on the second PF 31.

The service system function block group 33 is a collection of service applications. Each service application shall have one or more SW-C. The service applications are provided by third parties as well as the vehicle manufacturer who manufactured the vehicle. The third party that provides service applications includes, for example, data utilization companies that provide services by collecting data from vehicles.

The second PF 31 includes a control system function block group 35, a data system function block group 36, and an API gateway 40.

The control system function block group 35 is a collection of programs equipped with an API for accepting requests related to vehicle control from the service system function block group 33. The control system function block group 35 includes an API group 37 composed of multiple APIs, and converts the API access request that is expressed in a vehicle-independent format and from the service system function block group 33 into an API access request expressed in a vehicle-dependent format and provides it to the real-time processing unit 20. The “vehicle-independent format” described above is a format common to vehicles (i.e., a format that absorbs differences in vehicle types). The “vehicle-dependent format” described above is a format specific to the vehicle.

The API provided by the control system function block group 35 includes a motion system API for controlling motion of the vehicle and a non-motion system API other than the motion system API. The API access request accepted by the motion system API is transferred to the control system function block group 35, and is transferred from the control system function block group 35 to the in-vehicle devices 5 to 7 which execute control based on the request via the vehicle interior communication network 8. The API access request accepted by the non-motion system API is transferred to the in-vehicle devices 5 to 7 which execute control based on the request via the vehicle interior communication network 8.

The data system function block group 36 is a collection of programs equipped with an API for handling vehicle data acquired and stored via the real-time processing unit 20. The data system function block group 36 has a function of abstracting and storing vehicle data expressed in the vehicle-dependent format supplied from the real-time processing unit 20 into the vehicle-independent format. The data system function block group 36 may have an API that provides a function to transmit designated vehicle data to the ECU or the like via the Ethernet. In particular, when the transmission destination is the vehicle exterior communication device 7, the vehicle exterior communication device 7 may upload the transmitted vehicle data to the cloud.

It should be noted that communication with other in-vehicle devices 5 to 7 via the control system function block group 35 is not limited to CAN FD, but Ethernet or other communication means may be used. In addition, communication with other in-vehicle devices 5 to 7 via the data system function block group 36 may be performed not only by Ethernet, but also by CAN FD or other communication means.

The API gateway 40 is configured by utilizing the functions of the virtual function bus (hereinafter referred to as VFB). The VFB is middleware that enables communication between SW-Cs and between SW-C and BSW without awareness of hardware or communication protocol, also called software bus. Communication between SW-Cs is access to API provided by another SW-C from SW-C.

Communication between SW-C and BSW is access to API provided by control system function block group 35 and data system function block group 36 from SW-C.

That is, the SW-Cs access various APIs via the API gateway 40 and use the functions provided by the accessed APIs to implement desired functions.

The SW-C transmits an API access request when using the API. The API access request includes at least an application ID of the service application including the SW-C from which the request is made and the API-ID, the information indicating the API to which the request is made.

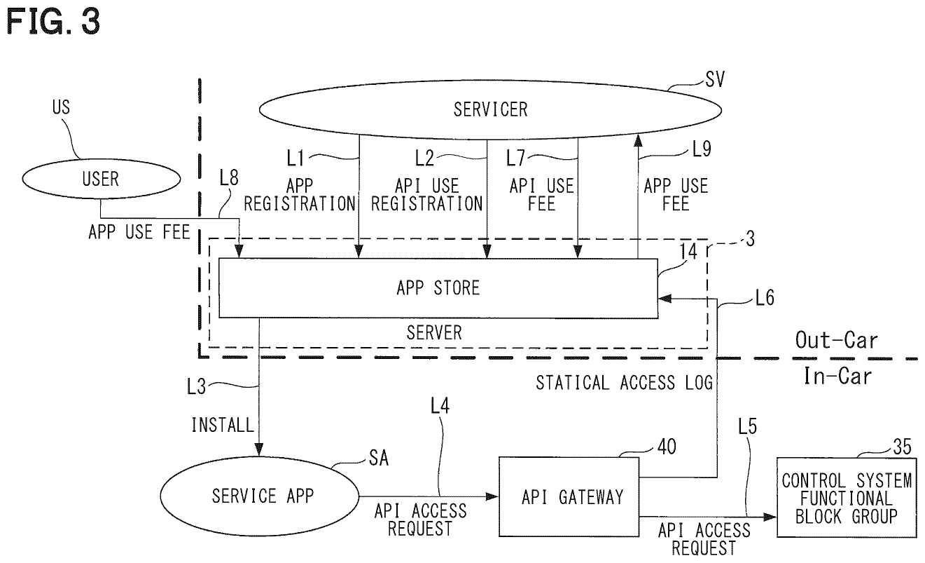

As shown in FIG. 3, an app store 14 is installed in the server 3. As indicated by an arrow L1, the app store 14 has a function of registering a service application SA manufactured by the servicer SV in the app store 14 based on an application by the servicer SV that has accessed the app store 14 using the servicer terminal device 9. The service application SA registered in the app store 14 is posted on the website of the app store 14.

Further, the app store 14 has a function of registering the API used by the service application SA in the app store 14 based on the application by the servicer SV, as indicated by an arrow L2.

When the user US accesses the website of the app store 14 and purchases the service application SA, the service application SA is installed in the ECU 4 mounted in the vehicle of the user US, as indicated by an arrow L3.

As indicated by an arrow L4, when the service application SA transmits an API access request to the API gateway 40, the API gateway 40 transfers the API access request to the control system function block group 35 as indicated by an arrow L5. As described above, the control system function block group 35 converts the API access request into an API access request expressed in the vehicle-dependent format and provides it to the real-time processing unit 20.

As indicated by an arrow L6, the API gateway 40 transmits a statistical access log to the app store 14, including the number of API uses taking into account the execution achievement status of the API access request and the amount of communication data associated with the API use.

The app store 14 calculates the API use fee generated by the use of the API by the service application SA based on the statistical access log received from the API gateway 40, and charges the servicer SV the API use fee. The servicer SV pays the charged API use fee to the app store 14, as indicated by an arrow L7.

The app store 14 calculates the application use fee of the service application SA based on the use state of the service application SA, and charges the user US for the application use fee. As indicated by an arrow L8, the user US pays the charged application use fee to the app store 14. As indicated by an arrow L9, the app store 14 transfers the application use fee paid by the user US to the servicer SV.

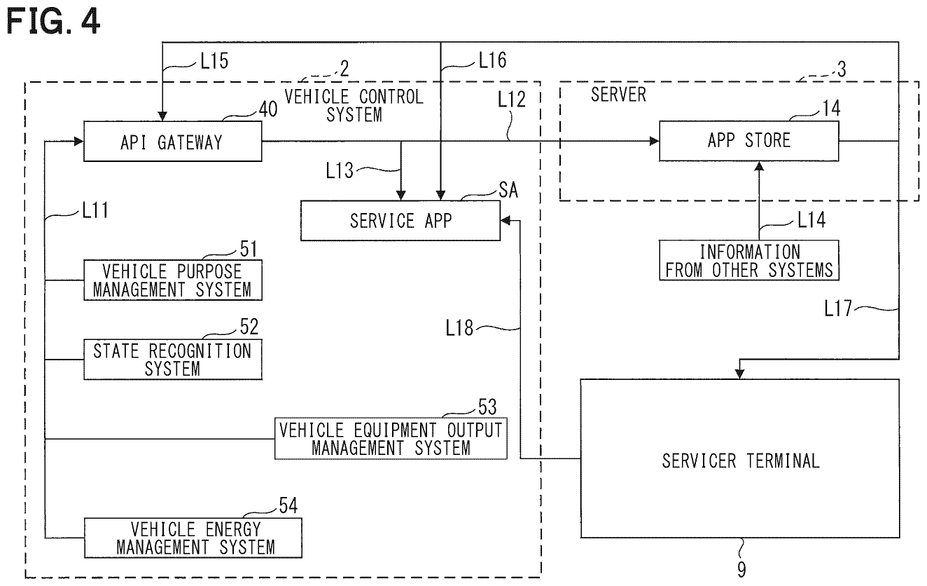

As shown in FIG. 4, the vehicle control system 2 includes a vehicle purpose management system 51, a state recognition system 52, a vehicle equipment output management system 53, and a vehicle energy management system 54.

The vehicle purpose management system 51 includes one or more in-vehicle devices 5 and 6 and has a function of generating a long-term plan for vehicle operation. The long-term plan of the vehicle operation includes a traveling schedule, a cabin temperature plan, an equipment operation application use plan, and the like.

The traveling schedule is prepared to reflect differences in the degree of brake and accelerator that differ depending on the vehicle and differences in driving characteristics of individuals. The traveling schedule is, for example, a vehicle speed profile, and is represented by a two-dimensional graph in which a horizontal axis is a time point [s] and a vertical axis is a vehicle speed [km/h].

The cabin temperature plan is, for example, an air conditioning profile, and is represented by a two-dimensional graph in which a horizontal axis is a time point [s] and a vertical axis is a temperature [° C.].

The device operation application use plan is, for example, a battery charge profile, and is represented by a two-dimensional graph in which a horizontal axis is a time point [s] and a vertical axis is a charge rate [%].

The state recognition system 52 includes one or more in-vehicle devices 5 and 6 and has a function of generating current vehicle information, current occupant information, current peripheral information, and a vehicle CPU load profile.

The current vehicle information is, for example, the current vehicle speed of the vehicle. The current occupant information is, for example, the occupant's alertness level. The current peripheral information is, for example, a sign existing in the periphery of the vehicle. The vehicle CPU load profile is, for example, a CPU load estimation plan until the vehicle arrives at the destination.

The vehicle equipment output management system 53 includes one or more in-vehicle devices 5 and 6 and has a function of generating current equipment operation state information and a vehicle equipment operation profile.

The current equipment operation state information indicates, for example, whether the vehicle light is on. The vehicle equipment operation profile is, for example, a two-dimensional graph in which a light is used in a tunnel or the like before reaching a destination, and a horizontal axis is a time point [s] and a vertical axis is a power [kWh].

The vehicle energy management system 54 includes one or more in-vehicle devices 5 and 6 and has a function of generating current vehicle energy state information and an energy long-term plan.

The current vehicle energy state information is, for example, information indicating the state of charge (that is, SOC) of the power storage device mounted on the vehicle. The SOC is an abbreviation for the state of charge.

The energy long-term plan is, for example, a battery load profile that estimates the SOC until the vehicle arrives at the destination, and is represented by a two-dimensional graph in which a horizontal axis is a time [seconds] and a vertical axis is a charge rate [%].

As indicated by an arrow L11, the API gateway 40 acquires various pieces of information generated by the vehicle purpose management system 51, the state recognition system 52, the vehicle equipment output management system 53, and the vehicle energy management system 54, and calculates the current API use fee and the future estimation amount of the API use fee.

As indicated by arrows L12 and L13, the API gateway 40 notifies the app store 14 and the service application SA of the calculated current API use fee and the future estimation amount of the API use fee.

The app store 14 acquires current API use fee information indicating the current API use fee and API estimation amount information indicating the future estimation amount of the API use fee from the API gateways 40 of the multiple vehicles. The app store 14 acquires information from other systems, as indicated by an arrow L14. The information from the different systems includes, for example, energy supply-demand information of the electric power company and rapid charger congestion information indicating the congestion status of the rapid charger.

The app store 14 calculates the future estimation amount of the vehicle API use fee using information acquired from the API gateways 40 and other systems of the multiple vehicles.

As indicated by arrows L15 and L16, the app store 14 notifies the API gateway 40 and the service application SA of the calculated future estimation amount of the vehicle API use fee.

As indicated by an arrow L17, the app store 14 notifies the servicer terminal device 9 of the current API use fee and the future estimation amount of the API use fee acquired from the API gateway 40 and the calculated future estimation amount of the vehicle API use fee.

As indicated by an arrow L18, the servicer terminal device 9 can set whether the service application SA will use the API based on the current API use fee and the future estimation amount of the API use fee.

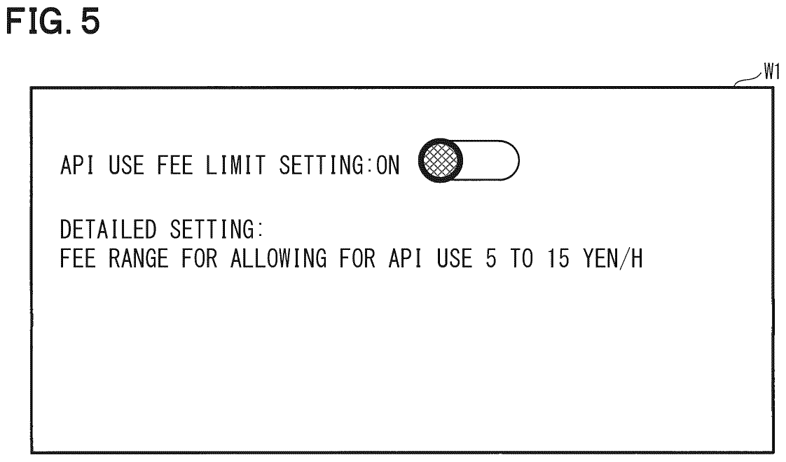

As shown in FIG. 5, the servicer terminal device 9 can display the API use fee limit setting window W1 on its display screen.

The API use fee limit setting window W1 is configured to turn on or off the API use fee limit setting. Furthermore, the API use fee limit setting window W1 can set a fee range that permits API use. The API use fee limit setting window W1 of FIG. 5 shows a state where the API use fee limit setting is on and the “fee range for permitting API use” is set to 5 to 15 [yen/hour].

The servicer terminal device 9 transmits the setting contents in the API use fee limit setting window W1 to the service application SA. As a result, the service application SA uses the API when the current API use fee and the future estimation amount of the API use fee are within the range of 5 to 15 [yen/hour], and does not use the API when the current API use fee and the future estimation amount of the API use fee are outside the range of 5 to 15 [yen/hour].

On the other hand, when the API use fee limit setting is turned off, the service application SA uses the API regardless of the current API use fee and the future estimation amount of the API use fee.

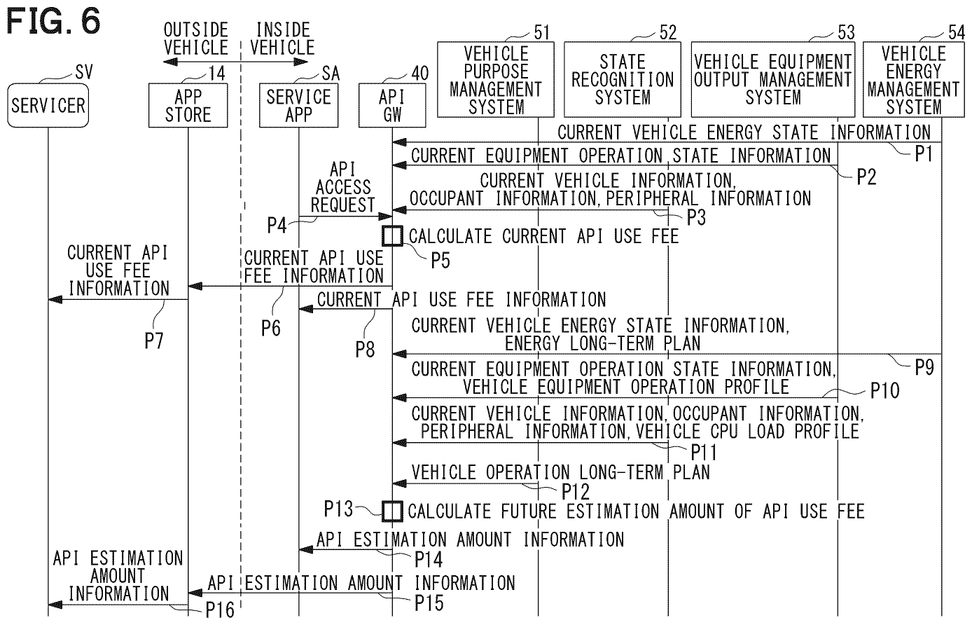

Next, as shown in FIG. 6, a procedure will be described in which the API gateway 40 calculates the current API use fee and the future estimation amount of the API use fee.

As shown in a process P1, the vehicle energy management system 54 transmits the current vehicle energy state information to the API gateway 40.

As shown in a process P2, the vehicle equipment output management system 53 transmits the current equipment operation state information to the API gateway 40.

As shown in a process P3, the state recognition system 52 transmits the current vehicle information, the current occupant information, and the current peripheral information to the API gateway 40.

As shown in a process P4, the service application SA transmits an API access request to the API gateway 40.

As shown in a process P5, the API gateway 40 calculates the current API use fee corresponding to the above API access request by the service application SA.

As shown in a process P6, the API gateway 40 transmits current API use fee information indicating the calculated current API use fee to the app store 14.

As shown in a process P7, the app store 14 transmits the received current API use fee information to the servicer SV.

As shown in a process P8, the API gateway 40 transmits current API use fee information indicating the calculated current API use fee to the service application SA.

As shown in a process P9, the vehicle energy management system 54 transmits the current vehicle energy state information and the energy long-term plan to the API gateway 40.

As shown in a process P10, the vehicle equipment output management system 53 transmits the current equipment operation state information and the vehicle equipment operation profile to the API gateway 40.

As shown in a process P11, the state recognition system 52 transmits the current vehicle information, the current occupant information, the current peripheral information, and the vehicle CPU load profile to the API gateway 40.

As shown in a process P12, the vehicle purpose management system 51 transmits a long-term plan of vehicle operation to the API gateway 40.

As shown in a process P13, the API gateway 40 calculates the future estimation amount of the API use fee for each of the multiple APIs.

As shown in a process P14, the API gateway 40 transmits API estimation amount information indicating the calculated future estimation amount of the API use fee to the service application SA.

As shown in a process P15, the API gateway 40 transmits API estimation amount information indicating the calculated future estimation amount of the API use fee to the app store 14.

As shown in a process P16, the app store 14 transmits the received API estimation amount information to the servicer SV.

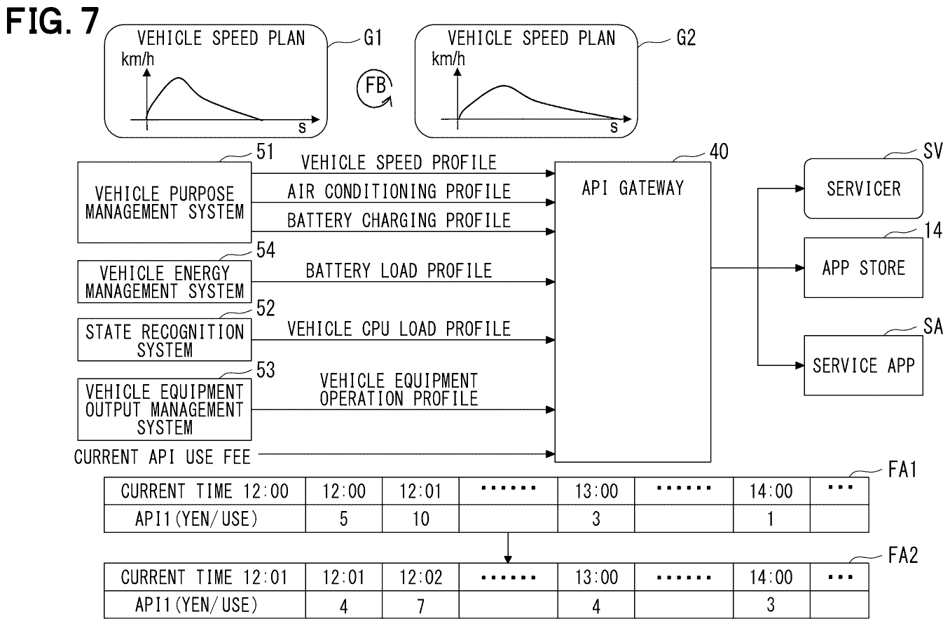

As shown in FIG. 7, the API gateway 40 acquires, for example, a vehicle speed profile, an air conditioning profile, and a battery charging profile from the vehicle purpose management system 51.

As shown in graphs G1 and G2, the vehicle speed profile is represented by a two-dimensional graph in which a horizontal axis is a time point [s] and a vertical axis is a vehicle speed [km/h]. The graph G1 shows the vehicle speed profile when the current time is 12:00. The graph G2 shows the vehicle speed profile when the current time is 12:01.

The API gateway 40 acquires, for example, a vehicle CPU load profile from the state recognition system 52.

The API gateway 40 acquires, for example, a vehicle equipment operation profile from the vehicle equipment output management system 53.

The API gateway 40 acquires, for example, a battery load profile from the vehicle energy management system 54.

The API gateway 40 calculates the future estimation amount of API use fee using the calculated current API use fee information and each acquired profile.

The API gateway 40 notifies the service application SA, the app store 14, and the servicer SV of the future estimation amount of the calculated API use fee.

The future estimation amount of the API use fee indicates the estimation amount of the API use fee at each predetermined time interval (one minute in the present embodiment) from the current time. API estimation amount information FA1 in FIG. 7 indicates the estimation amount of API use fee every minute from 12:00 onward. The API use fee is a fee per use of the API. API estimation amount information FA2 in FIG. 7 indicates the estimation amount of API use fee every minute from 12:01 onward. That is, the API gateway 40 generates the API estimation amount information FA1 at 12:00 and the API estimation amount information FA2 at 12:01.

The API estimation amount information FA1 and FA2 indicate, for example, the estimation amount of use fees when the API for turning on the vehicle lights is used.

In the API estimation amount information FA1 at the current time of 12:00, the API use fee estimation amount at 12:01 is 10 [yen/use], the API use fee estimation amount at 13:00 is 3 [yen/use], and the API use fee estimation amount at 14:00 is 1 [yen/use]. On the other hand, in the API estimation amount information FA2 at 12:01, the API use fee estimation amount at 12:01 is 4 [yen/use], the API use fee estimation amount at 13:00 is 4 [yen/use], and the API use fee estimation amount at 14:00 is 3 [yen/use]. In this way, since the API gateway 40 estimates the API use fee at each predetermined time interval, when the API estimation amount information FA1 and the API estimation amount information FA2 are compared, the estimation amount at the same time may be different.

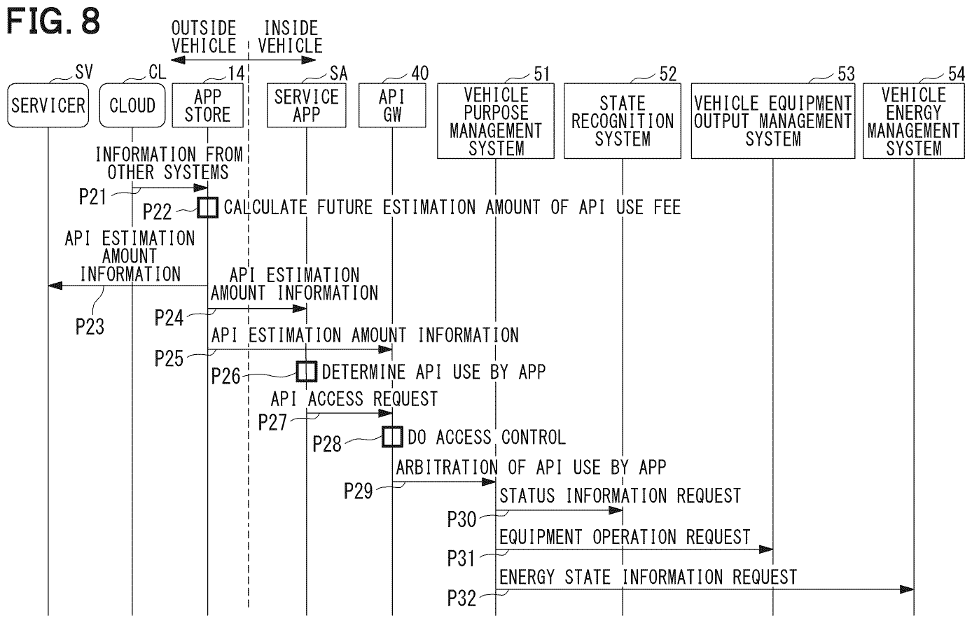

Next, as shown in FIG. 8, a procedure for calculating the future estimation amount of the vehicle API use fee and a procedure for the service application SA to make an API access request will be described.

As shown in a process P21, the app store 14 acquires, from a cloud CL, information obtained from the other systems. As described above, the information from the other systems includes, for example, energy supply-demand information of the electric power company and rapid charger congestion information.

As shown in a process P22, the app store 14 calculates the future estimation amount of the vehicle API use fee using the current API use fee information and API estimation amount information acquired from the API gateways 40 of the multiple vehicles and information from other systems.

As shown in a process P23, the app store 14 transmits API estimation amount information indicating the future estimation amount of the calculated API use fee to the servicer SV.

As shown in a process P24, the app store 14 transmits API estimation amount information indicating the future estimation amount of the calculated API use fee to the service application SA.

As shown in a process P25, the app store 14 transmits API estimation amount information indicating the future estimation amount of the calculated API use fee to the API gateway 40.

As shown in a process P26, the service application SA determines whether to use the API based on the acquired current API use fee information and API estimation amount information.

When the service application SA determines in the process P26 that it will use the API, it transmits an API access request to the API gateway 40 as shown in a process P27.

As shown in a process P28, the API gateway 40 receives the API access request from the service application SA and controls access to the control system function block group 35 including the API group 37.

As shown in a process P29, the API gateway 40 performs API access request arbitration, and requires, for example, the vehicle purpose management system 51 to execute a process according to the API access request from the service application SA as a result of arbitration. The API access request arbitration is a process of selecting one API access request from multiple accepted API access requests, setting the execution order of multiple accepted API access requests, and rejecting API access requests.

As shown in a process P30, the vehicle purpose management system 51, which has accepted the request to execute the process corresponding to the API access request, requests, for example, the state recognition system 52 to send state information (for example, current vehicle information, current occupant information, current peripheral information, and the like) generated by the state recognition system 52.

Further, as shown in a process P31, the vehicle purpose management system 51 requests, for example, the vehicle equipment output management system 53 to operate the vehicle equipment (for example, turn on a light).

Further, as shown in a process P32, the vehicle purpose management system 51 requests, for example, vehicle energy state information generated by the vehicle energy management system 54 from the vehicle energy management system 54.

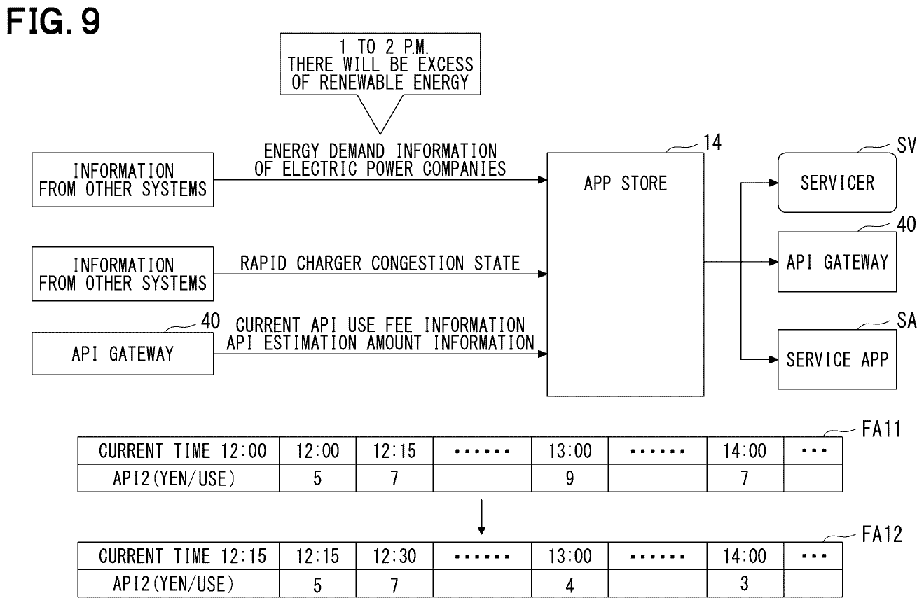

As shown in FIG. 9, the app store 14 acquires, for example, energy supply-demand information of a power company and rapid charger congestion information from other systems. The energy supply-demand information of the electric power company is, for example, information indicating that there is a high possibility of excess renewable energy between 13:00 and 14:00.

The app store 14 currently acquires API use fee information and API estimation amount information from the API gateways 40 of the multiple vehicles.

The app store 14 calculates the future estimation amount of the API use fee using the acquired information.

The app store 14 notifies the service application SA, the API gateway 40, and the servicer SV of the calculated future estimation amount of the API use fee.

The future estimation amount of the API use fee indicates the estimation amount of the API use fee at each predetermined time interval (15 minutes in the present embodiment) from the current time. API estimation amount information FA11 in FIG. 9 indicates the estimation amount of API use fee every 15 minutes from 12:00 onward. The API use fee is a fee per use of the API. API estimation amount information FA12 in FIG. 9 indicates the estimation amount of API use fee every 15 minutes from 12:15 onward. That is, the API gateway 40 generates the API estimation amount information FA11 at 12:00, and generates the API estimation amount information FA12 at 12:15.

The API estimation amount information FA11 and FA12 indicate, for example, the estimation amount of use fees when using the API to provide entertainment to vehicle occupants while using the rapid charger.

In the API estimation amount information FA11 at the current time of 12:00, the API use fee estimation amount at 12:00 is 5 [yen/use], the API use fee estimation amount at 12:15 is 7 [yen/use], the API use fee estimation amount at 13:00 is 9 [yen/use], and the API use fee estimation amount at 14:00 is 7 [yen/use]. On the other hand, in the API estimation amount information FA12 at 12:15, the API use fee estimation amount at 12:15 is 5 [yen/use], the API use fee estimation amount at 12:30 is 7 [yen/use], the API use fee estimation amount at 13:00 is 4 [yen/use], and the API use fee estimation amount at 14:00 is 3 [yen/use]. In this way, the app store 14 estimates the API use fee at each predetermined time interval, so when the API estimation amount information FA11 and the API estimation amount information FA12 are compared, the estimation amount at the same time point may be different.

Next, a procedure of the first calculation process executed by the API gateway 40 will be described. The first calculation process is a process repeatedly executed during the operation of the ECU 4.

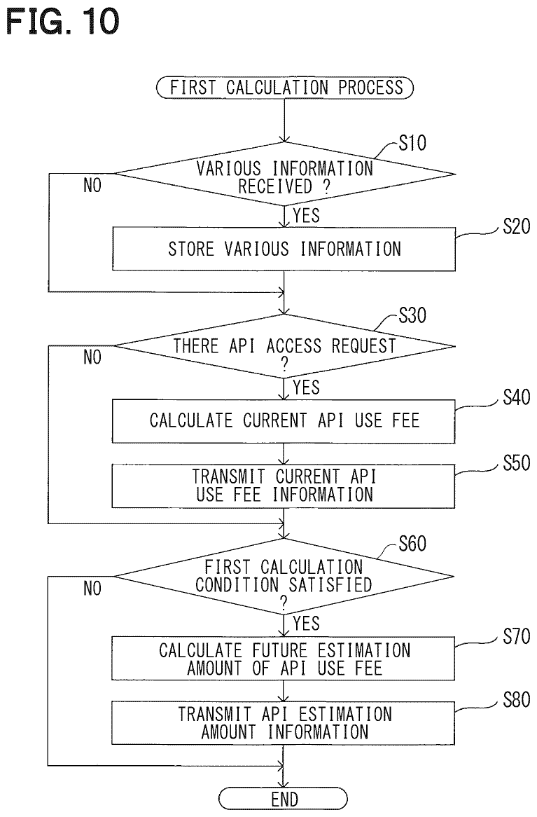

When the first calculation process is executed, as shown in FIG. 10, the API gateway 40 (hereinafter referred to as APIGW 40) determines in S10 whether various information has been received from the vehicle purpose management system 51, the state recognition system 52, the vehicle equipment output management system 53, and the vehicle energy management system 54.

The various information transmitted by the vehicle purpose management system 51 is the long-term plan of the vehicle operation described above.

The various information transmitted by the state recognition system 52 is the current vehicle information, the current occupant information, the current peripheral information, and the vehicle CPU load profile.

The various information transmitted by the vehicle equipment output management system 53 is the current equipment operation state information and the vehicle equipment operation profile described above.

The various information transmitted by the vehicle energy management system 54 is the current vehicle energy state information described above and the energy long-term plan.

Here, when various information has not been received, the APIGW 40 shifts to S30. On the other hand, when various information is received, the APIGW 40 stores the received various information in the RAM 4c in S20, and shifts to S30.

When shifting to S30, the APIGW 40 determines whether the API access request has been received. Here, when the API access request has not been received, the APIGW 40 shifts to S60. On the other hand, when the API access request has been received, in S40, the APIGW 40 calculates the current API use fee corresponding to the API access request received in S40 based on the current vehicle information, current occupant information, current peripheral information, current equipment operation state information, and current vehicle energy state information stored in S20, and the execution result of the API access request.

In S50, the APIGW 40 transmits the current API use fee information indicating the current API use fee calculated in S40 to the app store 14 and the service application SA corresponding to the API access request received in S40, and shifts to S60. The app store 14 transmits the received current API use fee information to the servicer terminal device 9.

When the process shifts to S60, the APIGW 40 determines whether the preset first calculation condition is satisfied. The first calculation condition of the present embodiment is that a preset first calculation cycle (one minute in the present embodiment) elapses.

Here, when the first calculation condition is not satisfied, the APIGW 40 ends the first calculation process. On the other hand, when the first calculation condition is satisfied, in S70, the APIGW 40 calculates the future estimation amount of the API use fee for each of the multiple APIs based on the long-term plan of the vehicle operation, the vehicle CPU load profile, the vehicle equipment operation profile, and the energy long-term plan stored in S20, and the calculated current API use fee information.

In S80, the APIGW 40 transmits API estimation amount information indicating the future estimation amount of the calculated API use fee to the service application SA, the app store 14, and the servicer terminal device 9, and ends the first calculation process.

Next, a procedure of the second calculation process executed by the app store 14 will be described. The second calculation process is a process repeatedly executed during the operation of the server 3.

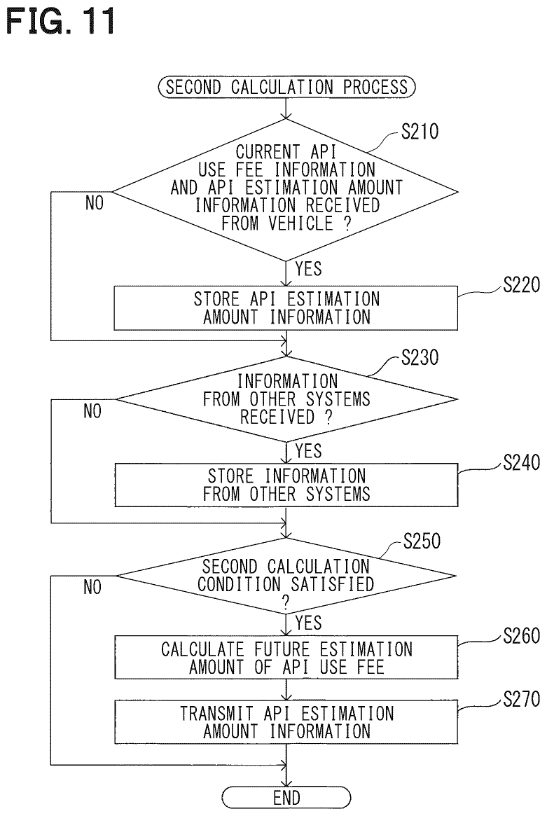

When the second calculation process is executed, as shown in FIG. 11, the app store 14 determines in S210 whether it has currently received the API use fee information or the API estimation amount information from the vehicle.

Here, when the current API use fee information or the API estimation amount information has not been received, the app store 14 shifts to S230. On the other hand, when the current API use fee information or the API estimation amount information has been received, the app store 14 stores the received current API use fee information or the received API estimation amount information in the storage 13 in S220, and shifts to S230.

When shifting to S230, the app store 14 determines whether information has been received from other systems. The information from other systems is the above-described energy supply-demand information and rapid charger congestion information.

Here, when the information has not been received from other systems, the app store 14 shifts to S250. On the other hand, when information is received from other systems, the app store 14 stores the information received from other systems in the storage 13 in S240, and shifts to S250.

When shifting to S250, the app store 14 determines whether the preset second calculation condition is satisfied. The second calculation condition of the present embodiment is that a preset second calculation cycle (15 minutes in the present embodiment) elapses.

Here, when the second calculation condition is not satisfied, the app store 14 ends the second calculation process. On the other hand, when the second calculation condition is satisfied, in S260, the app store 14 calculates the future estimation amount of the vehicle API use fee for each of the multiple APIs based on the current API use fee information and the API estimation amount information stored in S220 of the multiple vehicles and information stored in S240 from other systems.

In S270, the app store 14 transmits the API estimation amount information indicating the future estimation amount of the API use fee calculated in S260 to the service application SA, the APIGW 40, and the servicer terminal device 9, and ends the second calculation process.

The service provision system 1 configured as described above includes the vehicle control system 2 and the server 3.

The vehicle control system 2 is mounted on a vehicle. The vehicle control system 2 includes in-vehicle devices 4 to 7 connected to the vehicle interior communication network 8. The server 3 is capable of data communication with the vehicle control system 2.

The vehicle control system 2 includes the API gateway 40. The API gateway 40 implements cooperation between the service application SA configured to provide services to the vehicle and the control system function block group 35 configured to control the vehicle.

The control system function block group 35 includes the API group 37. The API group 37 converts the API access request expressed in the vehicle-independent format and transmitted from the service application SA into the vehicle-dependent format.

The API gateway 40 transfers the API access request transmitted from the service application SA to the control system function block group 35.

The API gateway 40 of the service provision system 1 acquires current vehicle information, which is current information about the vehicle, and future vehicle information, which is future information about the vehicle, based on information transmitted from the in-vehicle devices 5 and 6. The current vehicle information is the current vehicle information described above, the current occupant information, the current peripheral information, the current equipment operation state information, and the current vehicle energy state information. The future vehicle information is the long-term plan of the vehicle operation, the vehicle CPU load profile, the vehicle equipment operation profile, and the energy long-term plan described above.

The API gateway 40 of the service provision system 1 calculates the current API use fee, which is the API use fee generated by the service application SA using the API group 37, based on the current vehicle information.

The API gateway 40 of the service provision system 1 calculates the estimation amount (hereinafter referred to as a first future estimation amount) of the API use fee that will occur in the future due to the use of the API group 37 by the service application SA, based on the current vehicle information and future vehicle information.

The server 3 of the service provision system 1 acquires future external system information that is future information related to other systems from the other systems existing outside the service provision system 1. The future external system information is the above-described energy supply-demand information and rapid charger congestion information.

The server 3 of the service provision system 1 calculates the estimation amount (hereinafter referred to as a second future estimation amount) of API use fee that will occur in the future due to the use of the API group 37 by the service application SA, based on the first future estimation amount information and future external system information.

Such a service provision system 1 calculates the second future estimation amount, which is an estimation amount of API use fees that will occur due to the use of the API group 37 by the service application SA in the future, using not only the first future estimation amount information but also future external system information. Thereby, the service provision system 1 can improve the accuracy of calculating the estimation amount of API use fee that will occur due to the use of the API group 37 by the service application SA in the future. Therefore, the service provision system 1 can improve the reliability of the service provision system 1.

Further, in the service provision system 1, the vehicle control system 2 calculates first future estimation amount information that is information necessary for the server 3 to calculate the second future estimation amount. Thereby, in the service provision system 1, the server 3 can calculate the second future estimation amount without acquiring a huge amount of current vehicle information and future vehicle information from multiple vehicles. Therefore, the service provision system 1 can prevent the server 3 from calculating the second future estimation amount due to the high load on the server 3, and can further improve the reliability of the service provision system 1.

The service application SA is configured to determine whether to use the API group 37 based on at least one of the current API use fee or the second future estimation amount. Thereby, the service provision system 1 can cause the servicer SV to determine whether to promote or reduce the use of the API group 37 based on the API use fee.

In the embodiment described above, the vehicle interior communication network 8 corresponds to an in-vehicle network, the in-vehicle devices 4 to 7 correspond to multiple electronic control units, the control system function block group 35 corresponds to a control system function block, the API gateway 40 corresponds to a coordination controller, and the API group 37 corresponds to a functional interface.

Further, S10 to S20 correspond to processes as a vehicle information acquisition unit, S40 corresponds to a process as a use fee calculation unit, S70 corresponds to a process as a first estimation amount calculation unit, and the current API use fee corresponds to a process as a current interface use fee.

S230 to S240 correspond to an external information acquisition unit, S260 corresponds to a process as a second estimation amount calculation unit, and the other system corresponds to an external system.

Further, S50 and S80 correspond to processes as a system notification unit, and S270 corresponds to a process as a server notification unit.

As described above, the embodiment of the present disclosure is described, but the present disclosure is not limited to the above embodiment, and can be implemented with various modifications.

### First Modification

In the above embodiment, the API gateway 40 transmits the API estimation amount information to the app store 14, and the app store 14 transmits the received API estimation amount information to the servicer SV. However, the API gateway 40 may transmit the API estimation amount information directly to the servicer SV.

### Second Modification

In the above embodiment, the app store 14 calculates the second future estimation amount based on the current API use fee information, the first future estimation amount information, and the future external system information. However, the app store 14 may calculate the second future estimation amount based on the first future estimation amount information and future external system information without using the current API use fee information.

### Third Modification

In the above embodiment, the API gateway 40 of the vehicle control system 2 calculates the current API use fee based on the current vehicle information and calculates the first future estimation amount based on the current vehicle information and future vehicle information. However, the server 3 may acquire the current vehicle information and future vehicle information from the vehicle control system 2 to calculate the current API use fee and the first future estimation amount, and further calculate the second future estimation amount.

The ECU 4 and the method thereof described in the present disclosure may be implemented by a dedicated computer provided by configuring a processor and a memory programmed to execute one or a plurality of functions embodied by a computer program. Alternatively, the ECU 4 and the method described in the present disclosure may be implemented by a dedicated computer provided by configuring a processor with one or more dedicated hardware logic circuits. Alternatively, the ECU 4 and the method thereof according to the present disclosure may be implemented using one or multiple dedicated computers constituted by a combination of the processor and the memory programmed to execute one or more functions and the processor with one or more hardware logic circuits. The computer program may be stored in a computer-readable non-transitory tangible storage medium as an instruction to be executed by the computer. The method for realizing the functions of the respective units included in the ECU 4 does not necessarily need to include software, and all of the functions may be implemented with the use of one or multiple hardware.

Multiple functions of one configuration element in the above-described embodiment may be implemented by multiple configuration elements, or one function of one configuration element may be implemented by multiple configuration elements. Multiple functions of multiple configuration elements may be implemented by one configuration element, or one function implemented by multiple configuration elements may be implemented by one configuration element. Further, a part of the configuration of the above embodiment may be omitted. At least a part of the configuration of the embodiment may be added to or replaced with another configuration of the embodiment.

The present disclosure may be implemented, in addition to the server 3 and the ECU 4 described above, various forms such as a system including the server 3 and the ECU 4 as a component, a program for causing a computer to function as the server 3 and the ECU 4, a non-transitory tangible storage medium including a semiconductor memory storing the program, a service provision method.

What is claimed is:

1. A service provision system comprising:
a vehicle control system that includes:
a plurality of electronic control units mounted on a vehicle and connected to an in-vehicle network; and
a coordination controller configured to perform coordination between a service application configured to provide a service to the vehicle and a control system function block configured to control the vehicle; and
a server configured to communicate data with the vehicle control system,
wherein
the control system function block includes a functional interface configured to convert an access request that is expressed in a vehicle-independent format and transmitted from the service application into a vehicle-dependent format,
the coordination controller is configured to transfer the access request transmitted from the service application to the control system function block, and
the service provision system further comprises at least one of (i) a circuit and (ii) a processor with a memory storing computer program code executable by the processor, the at least one of the circuit and the processor configured to cause the service provision system to serve as:
a vehicle information acquisition unit configured to acquire current vehicle information that is current information related to the vehicle and future vehicle information that is future information related to the vehicle based on information transmitted from the plurality of electronic control units;
a use fee calculation unit configured to calculate a current interface use fee that is an interface use fee generated by the service application using the functional interface based on the current vehicle information;
a first estimation amount calculation unit configured to calculate a first future estimation amount that is an estimation amount of the interface use fee generated by the service application using the functional interface in future based on the current vehicle information and the future vehicle information;
an external information acquisition unit configured to acquire future external system information that is future information related to an external system from the external system existing outside the service provision system; and
a second estimation amount calculation unit configured to calculate a second future estimation amount that is an estimation amount of the interface use fee generated by the service application using the functional interface in the future, based on first future estimation amount information indicating the first future estimation amount and the future external system information.

2. The service provision system according to claim 1, wherein
the vehicle control system includes the vehicle information acquisition unit, the use fee calculation unit, and the first estimation amount calculation unit, and
the server includes the external information acquisition unit and the second estimation amount calculation unit.

3. The service provision system according to claim 2, wherein
the vehicle control system further includes a system notification unit configured to notify the server, the service application, and a servicer that provides the service to the vehicle using the service application of current interface use fee information indicating the current interface use fee and the first future estimation amount information.

4. The service provision system according to claim 2, wherein
the server includes a server notification unit configured to notify the coordination controller, the service application, and a servicer that provides the service to the vehicle using the service application of second future estimation amount information indicating the second future estimation amount.

5. The service provision system according to claim 1, wherein
the service application is configured to determine whether to use the functional interface based on at least one of the current interface use fee or the second future estimation amount.

6. The service provision system according to claim 1, wherein
the future vehicle information includes at least one of a long-term plan of vehicle operation, a vehicle computer processing unit load profile, a vehicle equipment operation profile, or an energy long-term plan.

7. The service provision system according to claim 1, wherein
the future external system information includes at least one of energy supply-demand information of a power company, or rapid charger congestion information indicating a congestion state of a rapid charger.

8. An in-vehicle device that is mounted on a vehicle and connected to a plurality of electronic control units by an in-vehicle network, the in-vehicle device comprising
at least one of (i) a circuit and (ii) a processor with a memory storing computer program code executable by the processor, the at least one of the circuit and the processor configured to cause the in-vehicle device to serve as
a coordination controller configured to perform coordination between a service application configured to provide a service to the vehicle and a control system function block configured to control the vehicle,
wherein
the control system function block includes a functional interface configured to convert an access request that is expressed in a vehicle-independent format and transmitted from the service application into a vehicle-dependent format,
the coordination controller is configured to transfer the access request transmitted from the service application to the control system function block, and
the at least one of the circuit and the processor is configured to further cause the in-vehicle device to serve as:
a vehicle information acquisition unit configured to acquire current vehicle information that is current information related to the vehicle and future vehicle information that is future information related to the vehicle based on information transmitted from the plurality of electronic control units;
a use fee calculation unit configured to calculate a current interface use fee that is an interface use fee generated by the service application using the functional interface based on the current vehicle information; and
a first estimation amount calculation unit configured to calculate a first future estimation amount that is an estimation amount of the interface use fee generated by the service application using the functional interface in the future, based on the current vehicle information and the future vehicle information.

9. A server comprising:
at least one of (i) a circuit and (ii) a processor with a memory storing computer program code executable by the processor, the at least one of the circuit and the processor configured to cause the server to serve as:
a communication unit configured to communicate data with
a vehicle control system that includes
a plurality of electronic control units mounted on a vehicle and connected to an in-vehicle network, and
a functional interface configured to convert an access request expressed in a vehicle-independent format into a vehicle-dependent format upon receiving the access request from a service application configured to provide a service to a vehicle equipped with the plurality of electronic control units;
an external information acquisition unit configured to acquire future external system information that is future information related to an external system from the external system existing in an outside; and
a second estimation amount calculation unit configured to calculate a second future estimation amount that is an estimation amount of an interface use fee generated by the service application using the functional interface in future based on first future estimation amount information indicating a first future estimation amount that is an estimation amount of the interface use fee generated by the service application using the functional interface in the future and the future external system information,
wherein
the first future estimation amount is calculated based on current vehicle information that is current information related to the vehicle and future vehicle information that is future information related to the vehicle.

10. A service provision method executed by a service provision system including: a vehicle control system that includes: a plurality of electronic control units mounted on a vehicle and connected to an in-vehicle network; a coordination controller configured to perform coordination between a service application configured to provide a service to the vehicle and a control system function block configured to control the vehicle; and a server configured to communicate data with the vehicle control system, the control system function block including a functional interface configured to convert an access request that is expressed in a vehicle-independent format and transmitted from the service application into a vehicle-dependent format, the coordination controller being configured to transfer the access request transmitted from the service application to the control system function block, the service provision method comprising causing the service provision system to:
acquire current vehicle information that is current information related to the vehicle and future vehicle information that is future information related to the vehicle based on information transmitted from the plurality of electronic control units;
calculate a current interface use fee that is an interface use fee generated by the service application using the functional interface based on the current vehicle information;
calculate a first future estimation amount that is an estimation amount of the interface use fee generated by the service application using the functional interface in the future, based on the current vehicle information and the future vehicle information;
acquire future external system information that is future information related to an external system from the external system existing outside the service provision system; and
calculate a second future estimation amount that is an estimation amount of the interface use fee generated by the service application using the functional interface in the future, based on first future estimation amount information indicating the first future estimation amount and the future external system information.

11. A non-transitory computer-readable storage medium storing a service provision program causing a computer of an in-vehicle device that is mounted on a vehicle and connected to a plurality of electronic control units by an in-vehicle network to serve as:
a functional interface configured to convert an access request that is expressed in a vehicle-independent format and transmitted from a service application configured to provide a service to the vehicle into a vehicle-dependent format;
a coordination controller configured to perform coordination between the service application and a control system function block configured to control the vehicle with the functional interface and transfer the access request transmitted from the service application to the control system function block;
a vehicle information acquisition unit configured to acquire current vehicle information that is current information related to the vehicle and future vehicle information that is future information related to the vehicle based on information transmitted from the plurality of electronic control units;
a use fee calculation unit configured to calculate a current interface use fee that is an interface use fee generated by the service application using the functional interface based on the current vehicle information; and
a first estimation amount calculation unit configured to calculate a first future estimation amount that is an estimation amount of the interface use fee generated by the service application using the functional interface in the future, based on the current vehicle information and the future vehicle information.

12. A service provision method executed by an in-vehicle device that is mounted on a vehicle and connected to a plurality of electronic control units by an in-vehicle network, the service provision method comprising causing the in-vehicle device, which includes: a functional interface configured to convert an access request that is expressed in a vehicle-independent format and transmitted from a service application configured to provide a service to the vehicle into a vehicle-dependent format; and a coordination controller configured to perform coordination between the service application and a control system function block configured to control the vehicle with the functional interface and transfer the access request transmitted from the service application to the control system function block, to:
acquire current vehicle information that is current information related to the vehicle and future vehicle information that is future information related to the vehicle based on information transmitted from the plurality of electronic control units;
calculate a current interface use fee that is an interface use fee generated by the service application using the functional interface based on the current vehicle information; and
calculate a first future estimation amount that is an estimation amount of the interface use fee generated by the service application using the functional interface in the future, based on the current vehicle information and the future vehicle information.

13. A non-transitory computer-readable storage medium storing a service provision program causing a computer to serve as:
a communication unit configured to communicate data with
a vehicle control system that includes
a plurality of electronic control units mounted on a vehicle and connected to an in-vehicle network, and
a functional interface configured to convert an access request expressed in a vehicle-independent format into a vehicle-dependent format upon receiving the access request from a service application configured to provide a service to a vehicle equipped with the plurality of electronic control units;
an external information acquisition unit configured to acquire future external system information that is future information related to an external system from the external system existing in an outside; and
a second estimation amount calculation unit configured to calculate a second future estimation amount that is an estimation amount of an interface use fee generated by the service application using the functional interface in future based on first future estimation amount information indicating a first future estimation amount that is an estimation amount of the interface use fee generated by the service application using the functional interface in the future and the future external system information,
wherein
the first future estimation amount is calculated based on current vehicle information that is current information related to the vehicle and future vehicle information that is future information related to the vehicle.

14. A service provision method executed by a server configured to communicate data with a vehicle control system in a service provision system including the server and the vehicle control system including a plurality of electronic control units mounted on a vehicle and connected to an in-vehicle network and a functional interface configured to convert an access request expressed in a vehicle-independent format into a vehicle-dependent format upon receiving the access request from a service application configured to provide a service to a vehicle equipped with the plurality of electronic control units, the service provision method causing the server to:
acquire future external system information that is future information related to an external system from the external system existing in an outside; and
calculate a second future estimation amount that is an estimation amount of an interface use fee generated by the service application using the functional interface in future based on first future estimation amount information indicating a first future estimation amount that is an estimation amount of the interface use fee generated by the service application using the functional interface in the future and the future external system information,
wherein
the first future estimation amount is calculated based on current vehicle information that is current information related to the vehicle and future vehicle information that is future information related to the vehicle.
